(19) United States
(12) Patent Application Publication
(10) Pub. No.: US 2011/0233338 A1
(43) Pub. Date: Sep. 29, 2011

(54) JOINT

(75) Inventor: David Mark STEWART, Belfast (GB)

(73) Assignee: AIRBUS OPERATIONS LIMITED, Bristol (GB)

(21) Appl. No.: 13/037,404

(22) Filed: Mar. 1, 2011

(30) Foreign Application Priority Data
Mar. 23, 2010 (GB) 1004757.9

(51) Int. Cl. B64C 3/00; B64C 1/00; B23P 11/00; B23P 17/00

(52) U.S. Cl. 244/131; 29/428; 29/407.05

(57) ABSTRACT

A joint between an aircraft wing box cover and a leading/trailing edge structure, the cover and the structure having flush aerodynamic outer surfaces, wherein the structure has an integrally formed land that extends over an inner surface of the cover, and the land of the structure is fastened to the cover. Also a method of forming the joint.

### FIELD OF THE INVENTION

The present invention relates to a joint between an aircraft wing box cover and a leading/trailing edge structure. The invention also relates to a method of forming such a joint.

### BACKGROUND OF THE INVENTION

Conventional aircraft wings comprise a wing box with front and rear spars. Upper and lower wing covers are attached to the spars and extend between them to form the upper and lower boundaries of the wing box. Leading and trailing edge structures, such as trailing edge shroud panels or D-nose covers, are typically attached to the upper and lower covers with butt-straps. FIG. 1 illustrates a conventional butt-strap arrangement.

An upper wing cover 1 is attached to a trailing edge shroud panel 2 with a butt-strap 3, a pair of bolts 4, 5 and nuts 9, 10. The butt-strap 3 comprises upper and lower horizontal portions 6, 7 which are joined by a vertical portion 8. The lower portion 6 engages with the inner surface of the cover 1, while the upper portion 7 engages with the inner surface of the panel 2.

To achieve a smooth aerodynamic surface, the outer surface of the panel 2 and the outer surface of the cover 1 must be aligned with each other within a strict tolerance range. Outside of this range, the step created in the outer surface across the joint leads to drag and increased fuel burn, and also issues with erosion of the edge of the panel 2. To ensure that the alignment criteria are met, a packer 11 may be added between the inner surface of the panel 2 and the upper portion 7 of the butt-strap, as shown in FIG. 1. Alternatively, the packer may be added between the inner surface of the cover 1 and the lower portion of the butt-strap. However, as the butt-straps 3 are typically fitted in various strips (nominally around 30 cm in length) across the whole span of the wing, this process can be difficult and time consuming. It may also be necessary to hand fettle the panel 2 to match the cover 1 during assembly. This adds further complexity to the process.

The problems with conventional butt-straps are particularly evident when used to join composite covers and panels, which typically have higher dimensional tolerance than their metallic counterparts. This may necessitate the use of “bespoke” butt-straps selected only once the exact dimensions of the composite parts are known. Moreover, the butt-straps used to join the composite covers and panels are typically metallic, which causes thermal loading issues resulting in an increase in structural weight to support the thermal loads. Also, the metallic butt-straps conventionally form part of the aircraft lightning diverter network, and so all the butt-straps have to be connected with jumper leads.

### SUMMARY OF THE INVENTION

A first aspect of the invention provides a joint between an aircraft wing box cover and a leading/trailing edge structure, the cover and the structure having flush aerodynamic outer surfaces, wherein the structure has an integrally formed land that extends over an inner surface of the cover, and the land of the structure is fastened to the cover.

A further aspect of the invention provides a method of forming a joint between an aircraft wing box cover and a leading/trailing edge structure, the method comprising: providing an aircraft wing box cover having an outer aerodynamic surface and an inner surface; providing a leading/trailing edge structure having an outer aerodynamic surface and an integrally formed land; arranging the cover and the structure such that their outer aerodynamic surfaces are flush, and the land of the structure extends over the inner surface of the cover; and fastening the land of the structure to the cover.

The invention is advantageous in that the butt-straps required in the prior art arrangement have been eliminated. The leading/trailing edge structure can now be joined to the wing box cover by a single row of fasteners. Although the land will add some structural weight, the elimination of the butt-straps and the second row of fasteners significantly reduces the weight and parts count of the joint Assembly is also made easier since there is no longer a requirement for “bespoke” butt-straps, or for multiple rows of fasteners.

The wing box cover and/or leading/trailing edge structure may be made of composite material. Since the butt-straps of the prior art arrangement have been eliminated, the troublesome thermal loading issues found in joining metallic butt-straps between composite parts have been circumvented.

The land may be used to support a conductor, such as a metallic mesh, of a lightning conductor network. In the prior art arrangement, each small (approximately 30 cm long) butt-strap had to be connected to its neighbouring butt-strap by a jumper lead to form the lightning diverter network. In an embodiment of this invention, the conductor supported by the land may extend along the length of the leading/trailing edge structure, leaving only conductors of adjacent leading/trailing edge structures (which may be several metres long) to be connected by jumper leads. This significantly reduces parts count, maintenance requirements and weight.

In one embodiment, the leading/trailing edge structure has a composite sandwich construction including a core sandwiched between outer skins. The core thickness may be reduced or terminated and the skins brought together to form the land.

The cover and structure may have opposing panel edges substantially perpendicular to their outer surfaces. This enables the fastener to be located as close as possible to the edge of the cover, so reducing bending stresses in the land.

The fastener is preferably releasable to permit disassembly of the joint. A nut and bolt combination is generally preferred. To retain a smooth outer surface across the joint, the bolt head is preferably countersunk in the outer surface of the cover.

Due to tolerance issues associated with composite materials, it is likely that some packer or shim will be required between the land and the inner surface of the cover, in order to align the outer aerodynamic surfaces. In a preferred embodiment, a shim washer of the required thickness is provided at the fastener location. The shim washer may be bonded, or otherwise fastened, to the land and/or the inner surface of the cover prior to fastening the land of the structure to the cover. To determine the required thickness of the shim, a gap between the land and the inner surface of the cover may be measured when their outer surfaces are flush, prior to fastening the land of the structure to the cover.

The cover may be an upper wing box cover or a lower wing box cover. The leading/trailing edge structure may be a leading edge D-nose or a trailing edge shroud panel. The flush outer surfaces form the outer aerodynamic surface of the wing.

### BRIEF DESCRIPTION OF THE DRAWINGS

Embodiments of the invention will now be described with reference to the accompanying drawings, in which:

FIG. 1 illustrates a conventional butt-strap arrangement between an aircraft wing cover and a trailing edge shroud panel;

FIG. 2 illustrates a joint between an aircraft wing cover and a trailing edge shroud panel in accordance with this invention; and

FIG. 3 illustrates the shroud panel having the land in detail.

### DETAILED DESCRIPTION OF EMBODIMENT(S)

An aircraft wing box upper cover 12 is attached to a trailing edge shroud panel 13 with a bolt 14 and nut 15. The cover 12 has an outer aerodynamic surface 16, an inner surface 17, and a trailing edge 18. The cover 12 forms part of an aircraft wing box structure of conventional type, and is fixed to the upper flange of the rear spar 19, as shown in FIG. 2. The panel 13 extends from the trailing edge 18 of the wing box structure to a trailing edge flap device (not shown), so as to complete the aerofoil profile of the wing. The panel 13 has an outer aerodynamic surface 20, an inner surface 21, a leading edge 22, and a land 23. The land 23 extends forwardly from the panel leading edge 22 over the inner surface 17 of the cover 12.

To achieve a smooth aerodynamic surface, the outer surface 16 of the cover 12 and the outer surface 20 of the panel 13 must be aligned with each other within a strict tolerance range. Outside of this range, the step created in the outer surface across the joint leads to drag and increased fuel burn, and also issues with erosion of the edge 22 of the panel 13. The outer surfaces 16 and 20 must therefore be flush within a tolerance range of the order of around ±0.5mm (depending on aerodynamic requirements). The opposing edges 18 and 22 are abutting save for a tolerance gap, the dimensions of which are also defined depending on aerodynamic requirements.

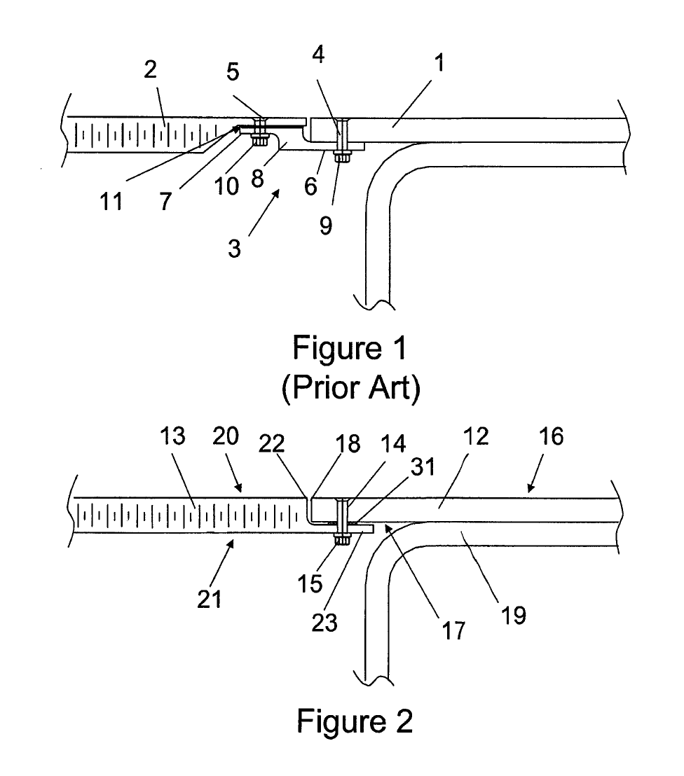

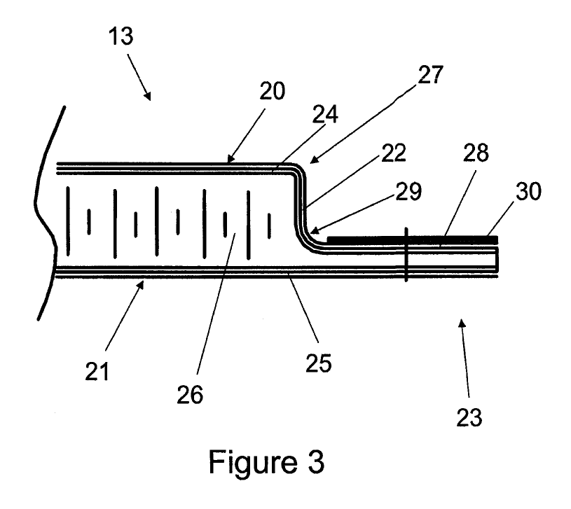

The cover 12 has fibre-reinforced laminate construction, such as carbon fibre-reinforced epoxy, for example. The cover 12 is virtually identical to the prior art cover 1 shown in FIG. 1, and has a nominal thickness of approximately 15 mm. However, there are structural ramps in the cover thickness in the wing spanwise direction. The panel 13 has a sandwich construction, comprising upper and lower skins 24 and 25 sandwiching a core layer 26. The sandwich construction is best seen in the detailed view of FIG. 3. The skins 24 and 25 each have a fibre-reinforced laminate construction, such as carbon fibre-reinforced epoxy, for example. The core layer 26 comprises a hollow cell material. This may be a closed cell foam, such as Rohacell™, a honeycomb, such as Nomex™, or any other suitable sandwich core material. The materials and construction of the sandwich panel 13 are similar to those of the prior art panel 2. For example, the bulk panel thickness is similar at around 20 mm. Also, the thickness of upper and lower skins 24, 25 is similar and includes 2 or 3 laminate plies each. However, the shape of the panel 13 adjacent the joint is different.

Importantly, the panel 13 has a sharp corner 27 between the outer surface 24 and the panel edge 22. A large radius here would fail the aerodynamic step tolerance requirements. As best shown in FIG. 3, the fibre-reinforced laminate plies of the upper skin 24 are continuous and form the outer surface 24, the panel edge 22, and the upper surface 28 of the land 23. The fibre-reinforced laminate plies of the lower skin 25 form the inner surface 21 of the panel 13, which is substantially planar. The panel edge 22 is set approximately perpendicular to the inner and outer surfaces 20, 21 of the panel 13. The sharp corner 27 may be created by laying up the laminate plies of the upper skin 24 against a sharp concave corner of a mould tool. Of course, the radius of the corner will be to some extent limited by the flexibility of the plies and so it may be necessary to use pressure intensifiers to improve the conformance of the plies to the mould profile. However, diffusion of the resin matrix into the corner will ensure exact conformance of the part to the mould profile. The fibre-reinforced laminate plies which form the panel edge 22 will form a good bond with the core layer 22, as they can be wet assembled.

The panel 13 has a larger radius 29 as the edge 22 transitions into the upper surface 28 of the land 23. This is dictated in some part by the mould tool, as a sharp convex edge of the mould tool would make lay up of the plies of the upper skin 24 difficult. However, the radius 29 causes no problems as there is intentionally a tolerance gap between the panel 13 and the cover 12, as will be described in detail later.

The land 23 extends forwardly of the leading edge 22 of the panel 13. The land 23 is integrally formed with the panel 13. The land thickness is approximately 5 mm, as compared to the bulk panel thickness, which is around 20 mm. This is achieved by tapering the thickness of the core layer 26 in the region of the land 23. It is particularly advantageous that the land is integrally formed with the panel 13 (rather than in the cover 12). The sandwich construction of the panel 13 makes it relatively straightforward to taper the core layer 26 and bring the upper and lower skins 24, 25 together to form the land. This means there is no requirement for shaping, or joggling, of the cover trailing edge. Shaping the cover trailing edge to form a land would require extensive ramps to drop off the requisite number of composite plies, which would need to extend many centimetres and lead to aerodynamic sealing issues.

As shown in FIG. 3, the upper surface 28 of the land 23 supports an electrically conductive mesh 30. The mesh 30 forms part of the aircraft wing lightning strike diverter network. The mesh 30 is preferably copper braid. A solid conductor could cause the land 23 to warp during curing step of manufacturing the panel 13.

The method of forming the joint will now be described in detail. The panel 13 has a series of pre-drilled countersunk holes at a nominal pitch of around 8 mm along the span of the panel leading edge for receiving the bolts 14. The cover 12 at this stage has no fastener receiving holes. The panel 13 is offered up to the cover 12, such that the outer surfaces 16 and 20 of the cover 12 and panel 13 are flush, within the aerodynamic step tolerance requirements. The panel 13 is position forwardly such that the radius 29 touches the edge 18 of the cover 12. A gap between the upper surface 28 of the land 23 and the inner surface 17 of the cover 12 is measured at each fastener location. The panel 13 is then removed.

A shim washer 31, or stack of washers, is bonded to the upper surface 28 of the land 23 at each fastener location. The washer thickness is determined according to the measured gap at each fastener location. The panel 13 is then once again offered up to the cover 12, and fastener receiving holes are drilled off though the trailing edge of the cover 12. Countersunk holes are then drilled in the outer surface 16 of the cover 12 at the fastener locations.

The bolts 14 are then inserted in the fastener holes through the cover 12 and the land 23 of the panel 13 and nuts 15 threaded to a predetermined tightening torque on the bolts 14 to attach the panel 13 to the cover 12. The outer surface of the completed joint will be flush.

The shim washers 31 are required as there will always be a gap between the upper surface of the land 23 and the inner surface of the cover 12. This is designed into the joint to ensure that it is always possible to align the outer surfaces 16 and 20 of the cover 12 and panel 13 flush. The shim washers 31 make it possible to easily attach the panel 13 to the cover 12, despite the spanwise structural ramps in the cover 12.

This process is then repeated, attaching panels 13 to covers 12 along the span of the wing as desired. Finally, the conductors 30 for the lightning diverter network are connected with jumper leads between the panels 13.

Although the invention has been described above with reference to one or more preferred embodiments, it will be appreciated that various changes or modifications may be made without departing from the scope of the invention as defined in the appended claims.

1. A joint between an aircraft wing box cover and a leading/trailing edge structure, the cover and the structure having flush aerodynamic outer surfaces, wherein the structure has an integrally formed land that extends over an inner surface of the cover, and the land of the structure is fastened to the cover.

2. A joint according to claim 1, wherein the structure is fastened to the cover using a nut and bolt combination.

3. A joint according to claim 2, wherein the bolt is countersunk in the outer surface of the cover.

4. A joint according to claim 1, wherein a washer is disposed between the land of the structure and the cover.

5. A joint according to claim 4, wherein the washer is a shim washer.

6. A joint according to claim 1, wherein the cover and/or structure is made of composite material.

7. A joint according to claim 6, wherein the structure has a sandwich construction comprising a core sandwiched between outer skins.

8. A joint according to claim 7, wherein the core thickness of the structure is reduced or terminated and the skins brought together to form the land.

9. A joint according to claim 1, wherein the cover and the structure have opposing edges substantially perpendicular to their outer surfaces.

10. A joint according to claim 1, wherein the land supports a conductor for a lightning diverter network.

11. A joint according to claim 1, wherein the cover is an upper wing box cover or a lower wing box cover.

12. A joint according to claim 1, wherein the structure is a leading edge D-nose or a trailing edge shroud panel.

13. A method of forming a joint between an aircraft wing box cover and a leading/trailing edge structure, the method comprising:
providing an aircraft wing box cover having an outer aerodynamic surface and an inner surface;
providing a leading/trailing edge structure having an outer aerodynamic surface and an integrally formed land;
arranging the cover and the structure such that their outer aerodynamic surfaces are flush, and the land of the structure extends over the inner surface of the cover; and
fastening the land of the structure to the cover.

14. A method according to claim 13, wherein the step of arranging the cover and the structure further comprises measuring a gap between the land and the inner surface of the cover when their outer aerodynamic surfaces are flush; and fixing shim material to the land and/or the inner surface of the cover at the fastener location as required to fill the gap.

15. A method according to claim 13, wherein the joint is formed between an aircraft wing box cover and a leading/trailing edge structure, the cover and the structure having flush aerodynamic outer surfaces, wherein the structure has an integrally formed land that extends over an inner surface of the cover, and the land of the structure is fastened to the cover.
